(19) United States
(12) Patent Application Publication
(10) Pub. No.: US 2013/0037683 A1
(43) Pub. Date: Feb. 14, 2013

(54) DOCUMENTS-HANGING SHOWCASE WITHOUT THE UTILIZATION OF CLIPS AND METHOD FOR ITS REALIZATION

(71) Applicant: Luigi Bertaso, Lugo Di Grezzana (Verona) (IT)

(72) Inventor: Luigi Bertaso, Lugo Di Grezzana (Verona) (IT)

(21) Appl. No.: 13/504,784

(22) PCT Filed: Oct. 29, 2010
(86) PCT No.: PCT/IB2010/054906

§ 371 Date: May 30, 2012

(30) Foreign Application Priority Data
Oct. 29, 2009 (IT) VR2009A000180

(51) Int. Cl. A47B 97/02; B23P 11/00

(52) U.S. Cl. 248/452; 29/428

(57) ABSTRACT

Showcase made up of a support structure, with a flat portion and an upper portion for holding sheets, wherein the upper portion is configured as a housing with at least one eyelet-configured open end so as to contain a plurality of rolling ball elements adapted to hold the sheet against the flat portion given that the sheet is inserted in the upper portion.

### TECHNICAL FIELD

The present invention regards a documents-hanging showcase for fixing documents and/or sheets, in general, eliminating the use of clips, and a method for providing the same. This showcase may be used in various sectors: offices, homes, schools, public businesses and anywhere it is required to display any document and/or sheet.

### DESCRIPTION OF RELATED ART

This showcase can be considered an innovation of the previously existing notice board or of the board for holding documents, which represent the most similar product today.

Prior art notice boards use, for fixing documents of any size, a system with pins, magnets or staplers; the novelty of this notice board lies in the elimination of any kind of pin for fixing documents and/or sheets.

Indeed, fixing a document on a board or notice board usually requires equipment that allows this operation, such as the abovementioned magnets, pins, staples, adhesive tape or other fixing systems.

Thus, using the prior art notice boards or boards requires, for fixing and/or hanging a document, positioning the sheet on the structure, holding it with one hand, holding the pin of any type on the other hand and fixing the sheet using such pin.

Thus, both hands of a user are involved in fixing the document to be fixed.

This notice board allows eliminating this uncomfortable and slow fixing system. This leads to the following advantages:

easy and quick insertion, fixing and extraction through a slight movement of several documents in line;

no laceration of the documents during the abovementioned processes;

comfort and elimination of all the various types of fixing means currently available which lead to uncomfortable operations and loss of time.

### SUMMARY OF THE INVENTION

Thus, the technical task of the present invention is that of improving the state of the art.

A further object of the present invention consists in providing a showcase for holding documents useable just by means of a single action of the hand, without using pins.

Another object of the present invention consists in providing an inexpensive and practical showcase.

These and other objects are attained by means of a showcase for holding documents according to one or more of the attached claims.

A further object of the present invention is obtained by providing a method for obtaining a showcase for holding documents according to the present invention that is simple and practical to use and assemble.

A further object of the present invention is obtained by providing an economical method for obtaining a showcase for holding documents according to the present invention.

These and other objects are attained by the method for providing a showcase for holding documents according to one or more of the attached claims.

### BRIEF DESCRIPTION OF THE DRAWINGS

These and other advantages shall be clearer to a man skilled in the art from the description that follows and from the attached drawings, provided by way of non-limiting example, wherein:

FIG. 1 represents a perspective view of the showcase for holding documents according to the present invention;

FIG. 2A represents a side view of the showcase for holding documents represented in FIG. 1;

FIG. 2B represents a side view of an embodiment of the showcase for holding documents according to the present invention;

FIG. 2C represents a side view of a further embodiment of the showcase for holding documents according to the present invention;

FIG. 2D represents a side view of a further embodiment of the showcase for holding documents according to the present invention;

FIG. 3 represents a detail of the showcase for holding documents represented in FIGS. 1 and 2A;

FIG. 4 represents a further detail of the showcase for holding documents represented in the preceding figures;

FIG. 5 represents an embodiment of the showcase for holding documents represented in the preceding figures;

FIG. 6 represents a component of the showcase for holding documents according to the present invention;

FIG. 7 represents un further component of the showcase for holding documents according to the present invention;

FIG. 8A represents a perspective view of a further component of the showcase for holding documents according to the present invention;

FIG. 8B represents a perspective view of a further embodiment of the further component of the showcase for holding documents according to the present invention;

FIG. 8C represents the component represented in FIG. 8A associated to the showcase of the preceding figures;

FIG. 8D represents the component represented in FIG. 8B associated to the showcase of the preceding figures;

FIG. 8E represents a further embodiment of the showcase for holding documents according to the present invention;

FIG. 9 represents an assembled component of the showcase for holding documents according to the present invention represented in FIGS. 6 and 7;

FIG. 10 represents an embodiment of the showcase for holding documents of the preceding figures.

FIG. 11 represents a detail of the showcase for holding documents of the preceding figures; and

FIG. 12 represents an embodiment of the showcase according to the preceding figures.

### DETAILED DESCRIPTION OF PREFERRED EMBODIMENTS

A showcase for holding documents according to the present invention is indicated in its entirety with 1.

Showcase 1 is a new device for fixing documents eliminating the use of pins, as observable in the attached figures.

The showcase 1 can be in form of a notice board and/or board and/or a support for fixing documents or sheets 8 of various types.

This showcase 1 is made up of at least three mutually assemblable parts.

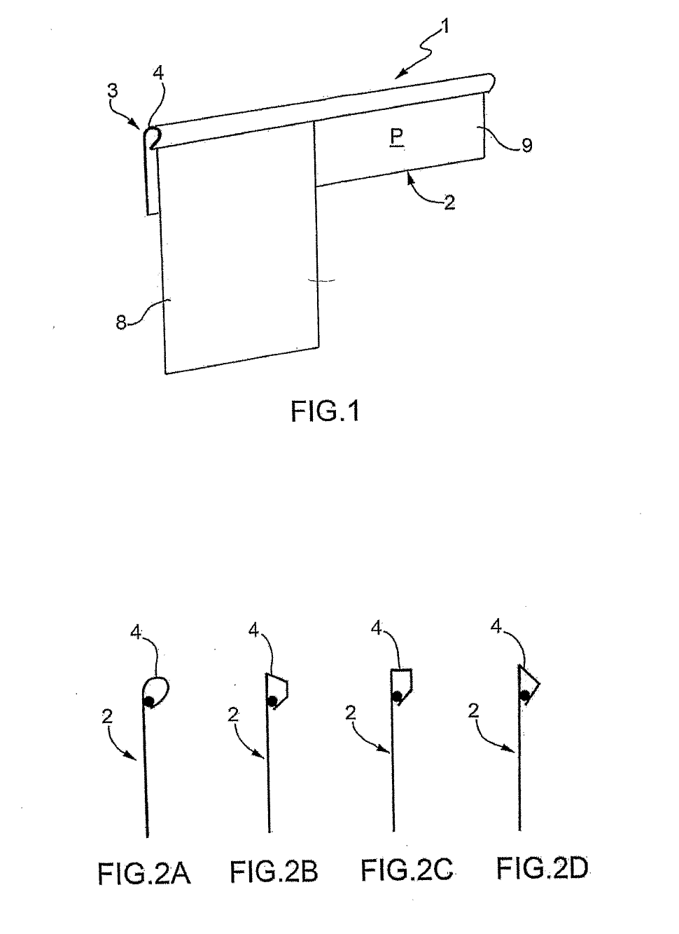

The showcase 1 is made up of a support structure 2, as observable in FIG. 1 and the subsequent ones.

The support structure 2 is substantially rigid.

The support structure 2 can be made of various materials, such as plastic materials and/or derived materials, and/or ferrous and/or non-ferrous metals of any kind or any other existing material.

The support structure 2 can be obtained through melting, extrusion or through bending any previously existing material usually used for such purpose.

The shape of the support structure 2 may vary to suit any design; there are endless possible shapes that can be obtained to confer a unique aspect to the showcase 1, as observable in FIGS. 2A, 2B, 2C, 2D.

The dimensions of the support structure 2 may vary from 1 mm to 5000 mm in length and height and from 1 mm to 500 mm in width.

The support structure 2 comprises a flat portion 9, substantially extended along the plane P, substantially vertical, of the wall or of the support on which the showcase 1 is fixed and/or positioned.

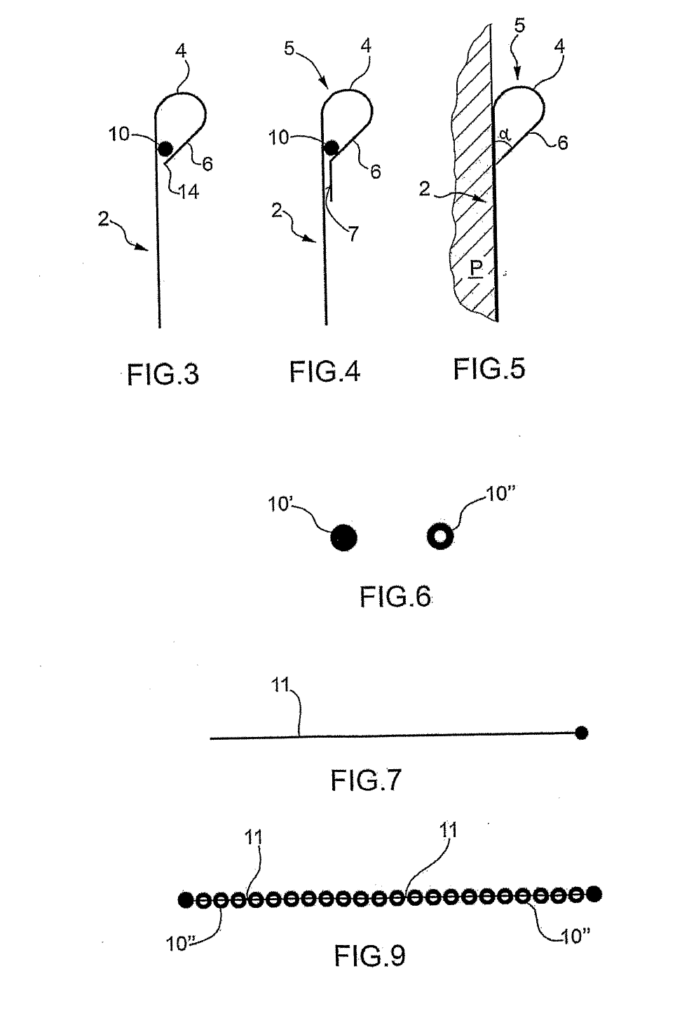

The support structure 2 comprises a housing-configured upper portion 3 and having at least one eyelet-configured open end 4, as observable in FIGS. 3 to 5. The size of the eyelet-configured end 4 may vary in height and width from 1 mm to 500 mm and from 1 mm to 5000 mm in length. The eyelet-configured end 4 may assume various configurations, some of which are represented purely by way of non-limiting example in the attached drawings.

The housing-configured upper portion 3 comprises a first portion 5 substantially curved or variously configured, substantially transverse configured with respect to the plane P or to the flat portion 9 and projecting therefrom.

The housing-configured upper portion 3 comprises, furthermore, an end portion 6, which branches from the first portion 5 and substantially inclined towards the flat portion 9 of the support structure 2, the end portion 6 having a free edge 14, which determines a throttling opening 7.

The eyelet-configured end 4 has an arched section or polygonal configuration.

The opening 7 corresponds to the distance between the free edge 14 of the end portion 6 and the flat portion 9 of the showcase 1.

The opening 7, as observable in FIGS. 3-5, serves for the insertion of the sheets 8 and it may vary from 0.1 mm a 500 mm.

Considering the flat portion 9 of the support structure 2, the end portion 6 of the upper portion 3 may be provided with an inclination, determined by the angle α, from 0° to 360°, as observable in FIG. 5.

Preferably, the angle α is comprised between 0° and 180° and even more preferably between 30° and 60°. In an embodiment the angle α corresponds to 45°.

The upper portion 3, housing-configured, contains a plurality of rolling elements 10, 10′, 10″ which allow holding the sheet 8 on the flat portion 9 given that the sheet 8 is inserted into the opening 7 of the upper portion 3.

The plurality of rolling elements 10,10′, 10″ comprises balls 10,10″ provided with a through hole through which a pin 11 can be inserted, so that the balls 10,10″ are arranged in the upper portion 3 aligned with respect to each other and mutually connected by the pin 11, and/or solid balls 10, 10′ and/or rollers of various dimensions and types, and/or rolling container elements adapted to contain at least partly the plurality of rolling elements 10, 10′, 10″.

The balls 10, as observable in FIG. 6, represent an example of the rolling elements 10, 10′, 10″.

The rolling elements 10, 10′, 10″ may be made of any type of material, and they may be of different shapes, for example cylindrical, oval, octagonal, circular, etcetera.

The rolling elements 10, 10′, 10″ may be inserted into the upper portion 3 through the eyelet-configured end 4 and the dimensions thereof are such not to allow the exit from the opening 7.

The rolling elements 10 may thus be loose 10′ or bound 10″ and should be sized according to the size of the support structure 2 with a diameter varying from 0.1 mm to 500 mm.

The loose rolling elements 10′ are usually solid while the bound rolling elements 10″ are usually perforated.

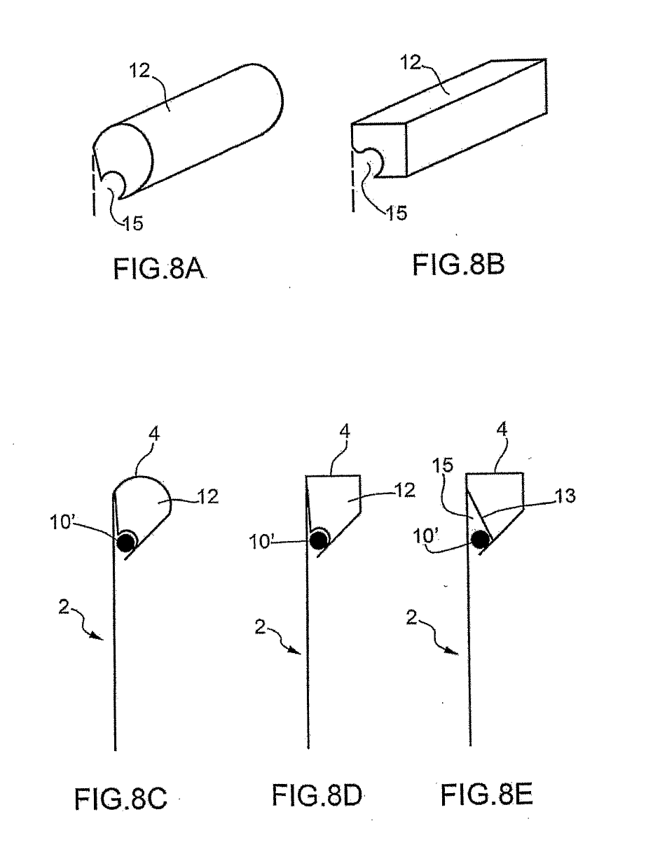

The bound rolling elements 10″ are provided with a pin 11, as observable in FIGS. 7 and 9; the loose rolling elements 10′ are provided with an insert 12 (FIG. 8A, 8B) or with a diagonal bar 13 (FIG. 8E).

In an embodiment, the rolling elements 10,10″ are provided with a through hole through which the pin 11 can be inserted, so that the rolling elements 10,10″ are arranged in the upper portion 3 aligned with respect to each other and mutually connected by the pin 11.

The pin 11, the insert 12 and/or the inclined bar 13 are used for constraining the rolling elements 10 thus preventing some movements thereof that could jeopardize the use of the showcase 1 itself.

The pin 11 is made up of a substantially wire-like element made of any material.

The insert 12 has a configuration substantially complementary to that of the upper portion 3 and of the eyelet-configured end 4 of the support structure 2 and it is slightly smaller, so as to allow the insertion of the insert 12 through the eyelet—configured end 4 simultaneously leaving a compartment 15 or empty space capable of allowing the rolling elements 10 to move, upwards, due to the pressure exerted by an operator inserting a document or sheet 8. Simultaneously such compartment 15, prevents the rolling elements from surmounting each other, thus eliminating the operation of the showcase 1. The inclined bar 13 serves the same function as the insert 12 and it is adapted to keep the rolling elements 10,10′, 10″ in the correct position.

The inclination of the end portion 6 of the upper portion 3 allows the rolling elements 10, 10′, 10″, present therein, to move upon the insertion of the sheets 8 holding them, simultaneously, under their weight on the flat portion 9.

The weight of the rolling elements varies accordingly upon the variation of the inclination of the end portion 6, with the aim of balancing the pressure exerted by the weight of the rolling elements, or the document and/or sheet 8, thus causing the holding thereof on the flat portion 9.

The pin 11 (FIG. 7) or the insert 12 (FIG. 8A, 8B, 8C, 8D), or the diagonal bar 13 (FIG. 8E), may be made using any type of material.

The pin 11, the insert 12 or the diagonal bar 13, prevent the rolling elements from surmounting each other, thus eliminating the operation of the showcase 1.

The pin 11, the insert 12, the diagonal bar 13 may vary, according to the length of the upper portion 3, from 1 mm to 5000 mm, and they may be obtained circular, octagonal, square-shaped or having other shapes.

The showcase 1 in a step of the embodiment further comprises closing means 16, possibly in form of caps.

The closing means 16 can assume a shape substantially complementary to that of the eyelet-configured end 4 so as to enable insertion thereinto thus closing the ends of the upper portion 3 of the support structure 2. Thus, the rolling elements 10 cannot exit from the showcase 1.

The closing means 16 may vary in terms of shape, size and the material they are made of.

Providing the showcase requires the assembly of the previously described parts sized according to the measurements of the parts and creating a reference scale for constructing the showcase.

Furthermore, the invention regards a method for providing a showcase 1, made up of a support structure 2, with a flat portion 9 and an upper portion 3 for holding sheets 8, comprising the steps of providing a support structure 2, with a flat portion 9 and an upper portion 3, configuring the upper portion 3, as housing, with at least one eyelet-configured end 4, inserting a plurality of rolling elements 10, 10′, 10″ into the upper portion 3 through the eyelet-configured end 4.

The method according to the invention comprises a step of providing the support structure 2 through at least one step of cutting strips to the size of the support structure 2 from metal sheets and/or strips in reels, or melting a plastic material forming the support structure 2, pouring the molten plastic material into a mold configured like the support structure 2, cooling the plastic material in the mold, extracting the finished support structure 2 from the mold.

In an embodiment, the configuration step occurs by bending using a bending machine and/or inclination by compressing and/or forming using a special horizontal flanging machine and special rollers, for forming a first portion 5, substantially curved or variously configured for substantially transverse configuration with respect to the flat portion 9 and projecting from the latter, an end portion 6, which branches from the first portion 5 and substantially inclined towards the flat portion 9, the end portion 6 having a free edge 14 which determines a throttling opening 7.

The method according to the invention comprises a step of providing the plurality of rolling elements 10, 10′,10″ by means of turning using a numerical control lathe and/or through a further known technique.

In a realization step, the method comprises a step of providing a pin 11 through extrusion or drawing and cutting.

In a further embodiment, the method comprises one of the steps of coupling the plurality of rolling elements 10, 10′, 10″ with the pin 11 through fitting the rolling elements 10,10′, 10″ into the pin 11, and possibly the step of closing the two ends of the pin 11 by compressing or through any other known technique adapted for the purpose of preventing the exit of the plurality of rolling elements 10,10′, 10″ from the pin 11, inserting the plurality of rolling elements 10, 10′, 10″ with the pin 11 into the upper structure 3 through the eyelet-configured end 4.

In an embodiment, the method according to the invention comprises a step of providing an insert 12 through extrusion or drawing and cutting.

The method according to the invention may comprise the steps of inserting, into the upper portion 3 of the support structure, the insert 12 and/or a diagonal bar 13 adapted to keep the plurality of rolling elements 10,10′, 10″ aligned, providing a compartment 15 or empty space between the insert 12 and/or between the diagonal bar 13 and the upper portion 3, fitting the plurality of rolling elements 10, 10′, 10″ into the compartment 15 or empty space.

In an embodiment, the method comprises a step of closing at least one eyelet-configured end 4 by inserting at least one closing means 16 (FIG. 11).

The closing means 16 may be fixed by means of a slight pressure on the support structure 2 so that, through a coupling created having shapes and dimensions of any kind, they are held at the ends of the support structure 2.

The abovementioned closing step comprises at least one of the steps of fixing at least one closing means 16 by slightly pressing, and/or fit coupling at least one closing means 16 into the eyelet-configured end 4, and/or compressing and closing the at least one eyelet-configured end 4.

The method according to the invention comprises a step of painting the showcase 1 using any color.

The method according to the invention further comprises a step of step of fixing the showcase 1 to a wall or in a previously existing notice board.

Fixing can be carried out using various systems (pressure caps, screws, both sides adhesive tape resistant to the weight of the structure 2, gluing using any silicone mastic).

The present invention further refers to the use of a showcase 1, made up of a support structure 2, with a flat portion 9 and an upper portion 3 for holding sheets 8, comprising the steps of inserting the sheet 8 into the upper portion 3, pushing, through the pressure exerted by the sheet 8, a plurality of rolling elements 10, 10′, 10″, holding the sheet 8 on the flat portion 9 through the pressure exerted onto the sheet by the plurality of rolling elements 10, 10′, 10″.

### Example 1

### Providing a Showcase 1 with a Pin 11 and Balls 10″

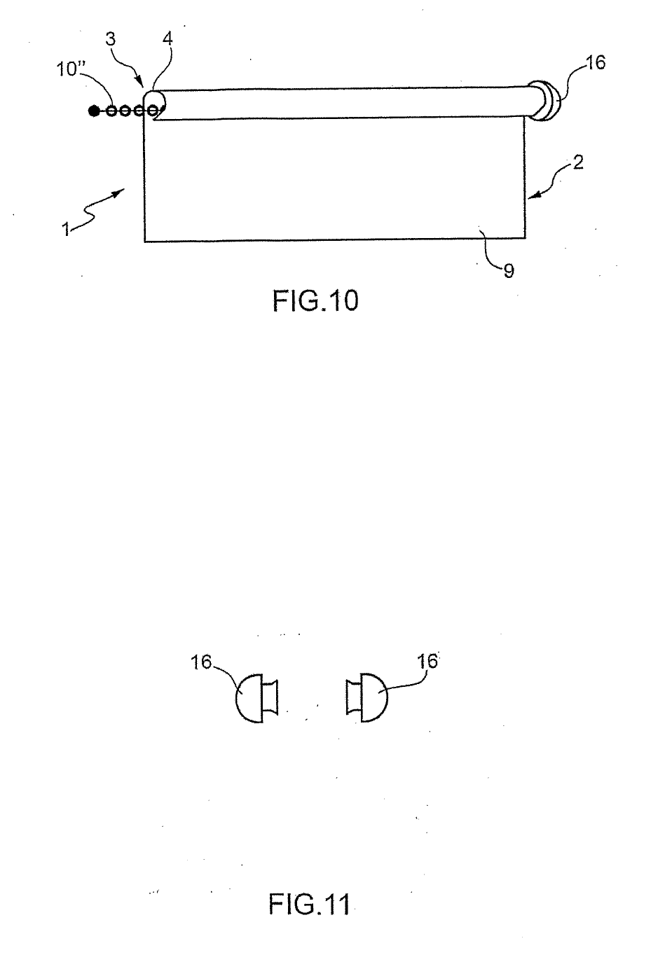

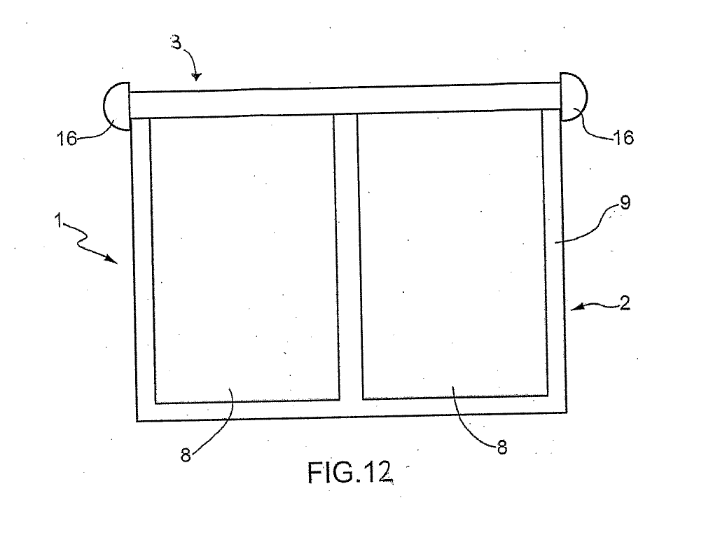

In an embodiment, the method comprises a first step of pin 11-balls 10″ coupling (FIG. 9); a second step of inserting the pin 1-balls 10″ coupling, thus obtained, into the compartment 15 of the upper portion 3 of the support structure 2 (FIG. 10).

The method further comprises a third step of side closing the support structure 2 through caps 16 (FIG. 11), which may vary in terms of shape, size and material. The caps 16 can be fixed through a slight pressure on the support structure 2 so that, through a coupling created with shapes and dimensions of each type, they are held at the ends of the support structure 2.

The method further comprises a fourth step of painting the showcase 1 using any color.

The method further comprises a fifth step of fixing the showcase 1 to the wall or in previously existing showcases.

### Example 2

### Providing a Showcase 1 with an Insert 12-Balls 10′ or a Diagonal Bar 13-Balls 10′

In a further embodiment, the method comprises a first step of inserting the insert 12 into the upper portion 3 through an eyelet-configured end 4 (FIG. 8A, 8B, 8C, 8D); in case of use of the diagonal bar 13 the latter is already inserted (FIG. 8E); a second step of closing a side of the upper portion 3 through an eyelet-configured end 4, inserting the balls 10′ into the resulting compartment 15 (FIG. 8C, 8D).

The method further comprises a third step of side closing the support structure 2 through at least one cap 16 (FIG. 11), which can vary in terms of shape, size and material. The caps 16 can be fixed through a slight pressure on the support structure 2 so that, through a coupling created having shapes and sizes of any kind, they are held at the ends of the support structure 2.

The method further comprises a fourth step of painting the showcase 1 using any color.

The method further comprises a fifth step of fixing the showcase 1 to the wall or in the previously existing showcases.

### Example 3

### Providing a Showcase 1 for Fixing A4 Sheets Measuring 48 cm (Length)×10 or 13 cm (Height), Made of Brass Metal, by Bending, with Pin 11 and Balls 10″. Providing the Support Structure 2

strips—of suitable size—for providing the support structure 2 (for a showcase where two sheets are fixed: 48×13 cm) are cut from brass metal sheets;

the first portion of the upper portion 3 and of the eyelet-configured end 4 is formed by bending using a bending machine;

subsequently, an inclination which completes the provision of the upper portion 3 and of the eyelet-configured end 4, leaving an opening 7 measuring a maximum of 2 millimeters in the end portion, is pressed thereinto by compression:

no painting is required given that it is brass.

Providing the balls:

brass balls 10″ measuring 6 mm with a central hole measuring 3 mm, are obtained from bars through turning using a numerical control lathe.

### Providing the pin 11 G:

the pin 11, with 2.5 mm diameter, is made of brass through extrusion or drawing, with a length of 44 cm;

the pin 11 is closed on one side by compression so as to prevent the exit of the balls 10″;

the pin 11 is then inserted into the perforated balls 10″;

lastly, the other side of the pin 11 is also closed by compression.

Assembling the portions:

the pin 11-balls 10″ coupling thus obtained is inserted in the compartment 15 of the upper portion 3;

then there follows the closing of the two eyelet-configured ends 4 with special caps 16.

### Example 4

### Providing a Showcase 1 for Fixing A4 Sheets Measuring 71 cm (Length) by 34 cm (Height) Through Plastic Melting, with Insert 11 and Balls 10′

Providing the support structure 2:

plastic is melted using a mold made to suit the size of the support structure 2, with the upper portion according to FIG. 2A, or 2B, or 2C, or 2D;

once the plastic is molten, it is poured into the mold and then left to cool;

once the plastic cools, the mold is opened and the finished piece is removed;
then painting is carried out using red epoxy powders in a continuous cycle oven.
   Providing the balls 10′ through turning from bars using a numerical control lathe:

solid brass balls 10′, with 5 mm diameter, are provided through turning from bars using a numerical control lathe.

Providing the insert 12:
the insert 12, measuring 68 cm, is made from plastic, through extrusion.

### Assembly:

the insert 12 thus obtained is inserted through the eyelet-configured end 4 into the upper portion 3, with an end closed previously;

the loose balls 10′ are introduced into the created compartment 15;

the other end is also closed.

### Example 5

### Providing the Showcase 1 with Pin 11 and Balls 10″

This showcase can obviously be reproduced at industrial level; following is a possible embodiment at industrial level.

Providing the support structure 2: The upper portion 3 having at least one eyelet-configured end 4 in continuous module is formed from a strip in reels—of suitable size—and made of the material the showcase 1 is intended to be made of, using a special horizontal flanging machine and special rollers.

The support structure 2 is cut to the desired size using a disc cutter or saw; painting is carried out using epoxy powders in a continuous cycle oven, using desired colors or leaving the natural color of the material used.

### Providing the pin 11:

The pin 11 is provided with a wire of suitable size already available in the market, by continuous cycle cutting and compressing a side to the desired size.

Providing the balls 10″:

The perforated balls 10″ are provided from bars using a numerical control lathe.

### Assembly:

The balls 10″ are coupled to the pin 11 using a special machine, with the automatic control of the number of required balls, and the other side is compressed.
Thus the pin 11-balls 10″ coupling is obtained.
The support structures 2 are loaded into a conveyor belt, advanced up to the point of intersection with the pin 11-balls 10″ coupling, the latter is inserted automatically into the compartment 15 of the upper portion 3 through an air piston, thus the two eyelet-configured ends 4 are closed using special caps 16.

### Example 6

### Providing a Showcase with Insert 12-Balls 10′

Providing the support structure 2:

The upper portion 3 with at least one eyelet-configured end 4 in continuous module is formed from strips in reels of suitable type and made of the material the showcase 1 is intended to be made of, using a special horizontal flanging machine and special rollers.

The support structure 2 is cut to the desired size using a cutter or circular saw: painting is carried out using epoxy powders in a continuous cycle oven, in the desired colors or leaving the natural color of the material used.

Providing the insert 12:

The insert 12 is provided through drawing in rods made of suitable material, cut using a circular saw automatically to the required size.

Providing the balls 10′:

The solid balls 10′ are available in the market at the required size.

### Assembly:

The support structures 2, previously closed on one side with special caps 16, are then loaded into a conveyor belt, advanced up to the point of intersection with the insert 12 which is inserted into compartment 15 of the upper portion 3 automatically using air pistons, the loose balls 10′ are introduced into the compartment 15 created with an automatic control of the required amount and the other side is closed using a cap 16, by means of an air piston.

The examples illustrated in the present description are intended solely for exemplifying and non-limiting purposes of the present invention. The various characteristics and/or method steps described for further embodiments, shall be deemed non-limiting for a particular embodiment but they can represent replacement and/or integration with respect to the characteristics and/or steps of other variant embodiments.

1-31. (canceled)

32. Showcase made up of a support structure, with a flat portion and an upper portion for holding sheets, wherein the upper portion is configured as a housing and it has at least one eyelet-configured open end so as to contain a plurality of rolling elements adapted to hold the sheet on said flat portion given that the sheet is inserted into said upper portion, wherein said plurality of rolling elements comprise solid balls and/or rollers of various dimensions and types and/or rolling container elements adapted to contain at least partly said plurality of rolling elements and comprises an insert or a flat surface, inclined with respect to the flat portion, insertable, through said eyelet-configured end, within said upper portion of said support structure, said insert or said flat surface being adapted to keep the plurality of rolling elements in the correct position.

33. Showcase according to claim 32, wherein said at least one eyelet-configured open end has arched section or polygonal configuration.

34. Showcase according to claim 32, wherein said support structure has dimensions that can vary from 1 mm to 5000 mm in length and height, and from 1 mm to 500 mm in width.

35. Showcase according to claim 32, wherein said eyelet-configured end measures from 1 mm to 500 mm in height and width, and wherein said upper portion measures from 1 mm to 5000 mm in length.

36. Showcase according to claim 32, wherein said housing-configured upper portion comprises a first portion, substantially curved or variously configured for substantially transverse configuration with respect to said flat portion and projecting from the latter, an end portion, which branches from said first portion and substantially inclined towards said flat portion, said end portion having a free edge which determines a throttling opening.

37. Showcase according to claim 36, wherein said opening corresponds to the distance between said free edge and said flat portion.

38. Showcase according to claim 36, wherein said opening is adapted for the insertion of the sheets and measures from 0.1 mm to 500 mm.

39. Showcase according to claim 36, wherein said end portion has an inclination, with respect to said flat portion equivalent to an angle α comprised between 0 and 180°.

40. Showcase according to claim 32, wherein said rolling elements have a diameter that can vary between 0.1 mm and 500 mm, with respect to the dimensions of said eyelet-configured end and of said upper portion within which they are positioned.

41. Showcase according to claim 32, wherein said insert has a configuration substantially complementary to that of said housing-configured upper portion and of said eyelet-configured end and dimensions slightly smaller than those of the latter, so as to allow the insertion of said insert through said eyelet-configured end.

42. Showcase according to claim 32, wherein said insert determines, within said upper portion of said support structure, a compartment or empty space adapted to contain said plurality of rolling elements.

43. Showcase according to claim 32, wherein said insert, said diagonal bar may vary, according to the width and length of said eyelet-configured end and said upper portion, from 1 mm to 5000 mm, and may be obtained circular, octagonal, square-shaped or other shapes.

44. Showcase according to claim 32, comprising at least one closing means possibly in form of a cap, whose shape is substantially complementary to that of said eyelet-configured end and adapted to close said at least one end of said upper portion.

45. Showcase according to claim 44, wherein said support structure, said flat portion, said upper portion, said plurality of rolling elements, and/or said insert and/or said diagonal bar, said closing means are made using materials, such as plastic materials and/or derivatives and/or ferrous and/or non-ferrous metals of any type or any other existing material.

46. Method for providing a showcase, made up of a support structure, with a flat portion and an upper portion for holding sheets, comprising the following steps:
providing a support structure, with a flat portion and an upper portion for holding sheets;
configuring said upper portion to obtain a housing with at least one eyelet-configured open end;
inserting a plurality of rolling elements into said upper portion through said eyelet-configured end;
providing an insert through extrusion or drawing and cutting;
inserting, into said upper portion of said support structure, said insert or a diagonal bar adapted to keep said plurality of rolling elements aligned;
providing a compartment or empty space between said insert or between said diagonal bar and said upper portion; and
fitting said plurality of rolling elements within said compartment or empty space.

47. Method for providing a showcase according to claim 46, comprising a step of providing said support structure by means of at least one of the following steps:
cutting strips to the size of said support structure from metal sheets and/or strips in reels, or
melting a plastic material forming said support structure,
pouring said molten plastic material into a mould configured like said support structure,
cooling said plastic material in said mould,
extracting the finished support structure from said mould.

48. Method for providing a showcase according to claim 47, wherein said step of configuring occurs by bending using a bending machine and/or inclination by compressing and/or forming using a special horizontal flanging machine and special rollers, for forming a first portion, substantially curved or variously configured for substantially transverse configuration with respect to said flat portion and projecting from the latter, an end portion, which branches from said first portion and substantially inclined towards said flat portion, said end portion having a free edge which determines a throttling opening.

49. Method for providing a showcase according to claim 47, further comprising a step of providing said plurality of rolling elements through turning using a numerical control lathe and/or through a further known technique.

50. Method for providing a showcase according to claim 47, further comprising a step of closing at least one eyelet-configured end by inserting at least one closing means.

51. Method for providing a showcase according to claim 50, wherein said step of closing comprises at least one of the following steps:
fixing said at least one closing means by slightly pressing, and/or
fit coupling said at least one closing means into said at least one eyelet-configured end, and/or
compressing and closing said at least one eyelet-configured end.

52. Method for providing a showcase according to claim 47, further comprising a step of painting said showcase.

53. Method for providing a showcase according to claim 47, further comprising a step of fixing said showcase to a wall and/or in a previously existing showcase.

54. Use of a showcase, made up of a support structure, with a flat portion and an upper portion for holding sheets, comprising the following steps:
inserting said sheet into said upper portion;
pushing, through the pressure exerted by said sheet, a plurality of rolling elements; and
holding said sheet on said flat portion through the pressure exerted onto the sheet by said plurality of rolling elements.
